(19) United States
(12) Patent Application Publication
(10) Pub. No.: US 2006/0248834 A1
(43) Pub. Date: Nov. 9, 2006

(54) Assembly unit including an inside door steel sheet and a carrier element

(76) Inventors: Thomas Heyer, Sassenburg (DE); Markus Waroch, Isenbuettel (DE); Laurent Cheramy, Grignon (FR); Francois-Paul Meurou, Sceaux du Gatinais (FR); Norbert Kleen, Wendeburg (DE)

Correspondence Address: CARLSON, GASKEY & OLDS, P.C., 400 WEST MAPLE ROAD, SUITE 350, BIRMINGHAM, MI, 48009, US

(21) Appl. No.: 11/401,996

(22) Filed: Apr. 11, 2006

(30) Foreign Application Priority Data
Apr. 15, 2005 (DE) 10 2005 017 615.1

(51) Int. Cl. E06B 3/70

(52) U.S. Cl. 52/455

(57) ABSTRACT

An assembly unit includes an inside door steel sheet and a carrier element that is fastened to the inside door steel sheet. The carrier element has at least one edge hung on the inside door steel sheet with a latching connection or a hook connection.

### RELATED APPLICATIONS

The application claims priority to German Application No. 10 2005 017 615.1 which was filed on Apr. 15, 2005.

### TECHNICAL FIELD

The invention relates to an assembly unit that includes an inside door steel sheet and a carrier element fastened to the inside door steel sheet.

### BACKGROUND OF THE INVENTION

In particular, a carrier element serves to accommodate various components of a window lifter system. For the purpose of an easy installation, the components of the window lifter system are pre-mounted to the carrier element, so that a finished carrier element can be delivered to a vehicle body and fastened to an inside door steel sheet. The term “inside door steel sheet” includes inner structural parts of lateral portions of a vehicle body, especially those of a vehicle door.

Currently, the carrier elements are fastened to the inside door steel sheet with screws. This involves some disadvantages, both in terms of installation time and cost. It is especially true that the installation time is increased by each single screw that has to be inserted and tightened during installation.

It is the object of the invention to further develop an assembly unit of the type initially mentioned such that a quicker installation is made possible.

### SUMMARY OF THE INVENTION

The subject invention accomplishes this by providing a carrier element that has one edge hung up on an inside door steel sheet by a latching connection or a hook connection. The invention is based on the fundamental idea to replace at least some of the previously required screw connections with a latching connection or a hook connection between the inside door steel sheet and the carrier element. This latching connection or hook connection can be obtained by simply assembling components, without the need for mounting additional components or tightening these additional components after assembly.

In doing so, it is not required that the latching connection or the hook connection establish a connection that can be acted upon in any direction, as is the case with a screw. It is sufficient when the connection is effective in a y-direction, i.e. retains the carrier element on the inside door steel sheet in a lateral direction. For final fastening, one may use other types of fastening, for instance a few screws.

It is preferred that the latching connection or the hook connection be detachable, so that the carrier element—in case repair or maintenance is required—can be detached from the inside door steel sheet. It is also true that the disassembling can be effected with lower expense than is the case with the screw connections which usually are provided in the prior art.

Advantageous designs of the invention will be apparent from the sub-claims.

These and other features of the present invention can be best understood from the following specification and drawings, the following of which is a brief description.

### BRIEF DESCRIPTION OF THE DRAWINGS

FIG. 1 shows a schematic cross-section through a door with an inside door steel sheet to which a carrier element is mounted.

FIG. 2 shows a first embodiment of the invention in a schematic cross-section.

FIG. 3 shows the first embodiment in a schematic perspective view.

FIG. 4 shows a second embodiment of the invention in a schematic section.

FIG. 5 shows the second embodiment in a schematic perspective view.

FIG. 6 shows a variant of the second embodiment in a schematic section.

FIG. 7 shows a third embodiment of the invention in a schematic section.

FIG. 8 shows the third embodiment in a schematic perspective view.

FIG. 9 shows a fourth embodiment of the invention in a schematic section.

FIG. 10 shows the fourth embodiment in a schematic perspective view.

FIG. 11 shows a fifth embodiment of the invention in a schematic section.

FIG. 12 shows the fifth embodiment in a schematic perspective view.

FIG. 13 shows a sixth embodiment of the invention in a schematic section.

FIG. 14 shows the sixth embodiment in a schematic perspective view, during installation of the carrier element on the inside door steel sheet.

FIG. 15 shows the inside door steel sheet for the sixth embodiment in a schematic view.

FIG. 16 shows a seventh embodiment of the invention in a schematic section.

FIG. 17 shows in a schematic perspective view of the seventh embodiment during installation.

FIG. 18 shows an eighth embodiment of the invention in a schematic section.

FIG. 19 shows the eighth embodiment in a schematic perspective view.

FIG. 20 shows a ninth embodiment of the invention in a schematic perspective view.

FIG. 21 shows a tenth embodiment of the invention in a schematic perspective view.

FIG. 22 shows an eleventh embodiment of the invention in a schematic perspective view.

### DETAILED DESCRIPTION OF THE PREFERRED EMBODIMENT

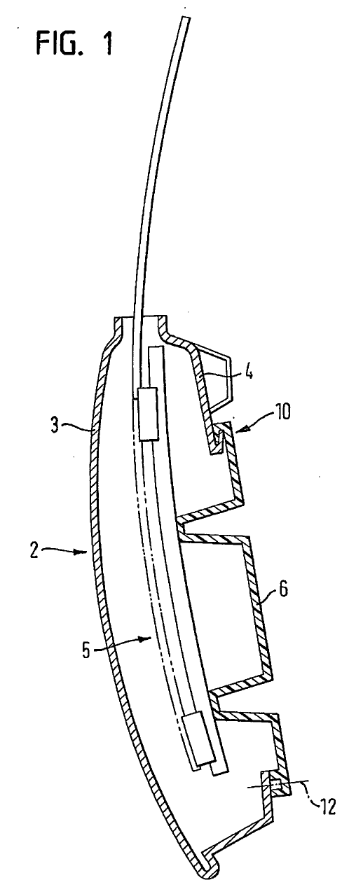

FIG. 1 shows a vehicle door 2, which as essential structural components has an outside door steel sheet 3 and an inside door steel sheet 4. Between the outside door steel sheet 3 and the inside door steel sheet 4 there is formed a cavity in which components of a window lifter system 5 are arranged. The window lifter system 5 is mounted to a carrier element 6 that is mounted to the inside door steel sheet 4. At an upper edge, the carrier element 6 generally has a latching connection or a hook connection 10 that mounts the upper edge of the carrier element 6 to the inside door steel sheet 4. A screw connection 12, which is schematically indicated here, may be provided at a lower edge.

With all embodiments that are shown here, the latching connection or the hook connection 10 is illustrated to be situated at the upper edge of the carrier element 6. As an alternative, the latching connection or hook connection 10 could also be arranged at the lower, front or rear edge of the carrier element 6.

The carrier element 6 is preferably made of plastic. The inside door steel sheet 4 is usually made of sheet metal, as is already suggested by the name. Indeed, the term “inside door steel sheet” also includes inner structural parts of a vehicle door when these parts are not made of metal, but instead made of plastic, for instance. The term “inside door steel sheet” also includes inner lateral structural parts when they are not part of a door, for instance at a side of a backseat of a coupe. For clarification it should be mentioned that the terms that are used in this context, such as “top.” “bottom,” etc., make reference to a vehicle which is in a normal position of operation, namely supported on wheels on the ground. Thus, “top” is further away from the ground than “bottom.”

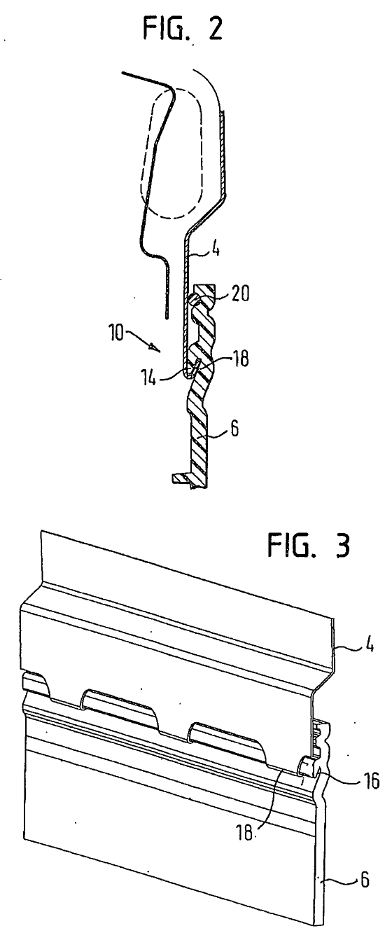

FIGS. 2 and 3 show a latching connection or a hook connection for an assembly unit according to a first embodiment. Provided at the upper edge of the carrier element 6 is a rib 14 that forms a groove 16 between the rib 14 and a body of the carrier element 6. A hook 18 engages in the groove 16. The hook 18 is provided on the inside door steel sheet 4 and extends obliquely toward the top. As can be seen in FIG. 3, a plurality of hooks 18 is provided that are spaced apart from each other. The hooks 18 can be formed by simply bending off a corresponding edge of the inside door steel sheet 4. For installation, the carrier element 6—with the components of the window lifter system 5 that are mounted to it—is hung up on the hook 18, i.e. is placed on the hook 18 obliquely from the top. In doing so, a seal 20 arranged above the rib 14 comes into contact with the inside door steel sheet 4, so that the carrier element 6 and the inside door steel sheet 4 are sealed at this upper location.

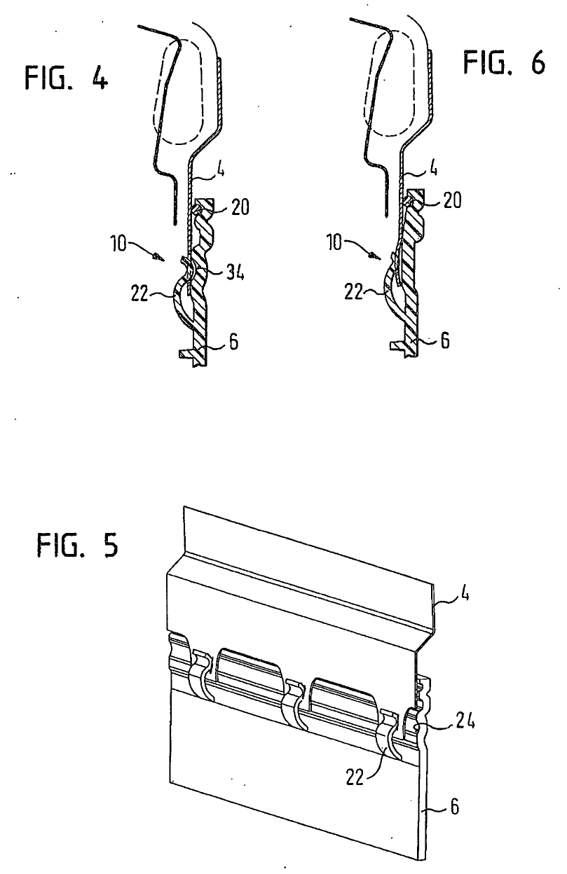

FIGS. 4 and 5 show a latching connection or a hook connection 10 according to a second embodiment. Here, the carrier element 6 is provided with a latching lug 22 extending towards the top. Underneath a latching portion of the latching lug 22, i.e. the portion providing for a mechanical connection with the inside door steel sheet 4, there is provided an indentation 24 on the carrier element 6. A plurality of recesses is provided on the inside door steel sheet 4, which each are associated to one latching lug 22. For installation, the carrier element 6 is added to the inside door steel sheet 4 from the bottom, so that the latching lugs 22 first spring outwards and then engage in the recesses of the inside door steel sheet 4, so that they come to lie in the indentation 24. Also with this embodiment there is provided a seal 20.

According to alternative embodiments that are not illustrated, the inside door steel sheet may include a bead instead of the recesses, with the latching portions of the latching lugs engaging in this bead. It is also possible to realize the inside door steel sheet in a planar configuration, so that the latching portions of the latching lugs rest flatly on the surface of the inside door steel sheet.

FIG. 6 shows a variant of the second embodiment. In order to provide for the required free space for a reliable engaging of the latching portion of the latching lug 22 in the corresponding recess of the inside door steel sheet 4, the edge associated to the inside door steel sheet 4 and engaged by the latching lug 22 is configured to have a curvature forming a clearance with the carrier element 6. Thus, the latching portion of the latching lug 22 can reach through the recess in the inside door steel sheet 4 to a sufficient extent and fasten the carrier element 6 to the inside door steel sheet 4.

Also with this variant, there may be provided a bead in the inside door steel sheet instead of the recesses, or the inside door steel sheet can be configured to be planar.

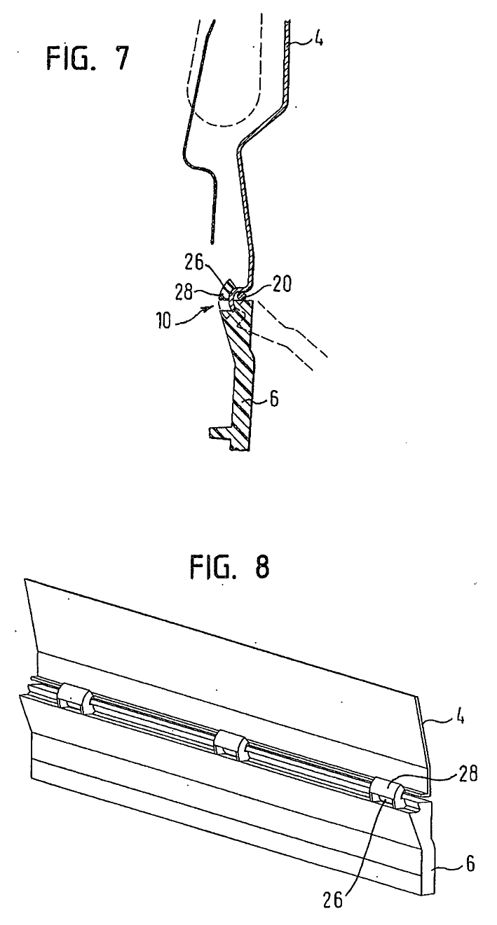

FIGS. 7 and 8 show a latching connection or a hook connection 10 for a third embodiment. Here, the inside door steel sheet 4 has an articulation lug 26 that extends in the shape of a circular arc across an angular section of approximately 45°. A counter bearing 28 defined on the carrier element 6 engages the articulation lug 26. The counter bearing 28 laterally encompasses the articulation lug 26 and defines a guideway intended for the articulation lug 26 and provided in the shape of a circular arc. The carrier element 6 can be added to the articulation lug 26 in the position that is shown in FIG. 7 in broken lines, and then swiveled downward by approximately 45°, so that the articulation lug 26 is undetachably received within the counter bearing 28. Also with this embodiment, there is provided a seal 20 between the inside door steel sheet 4 and the carrier element 6.

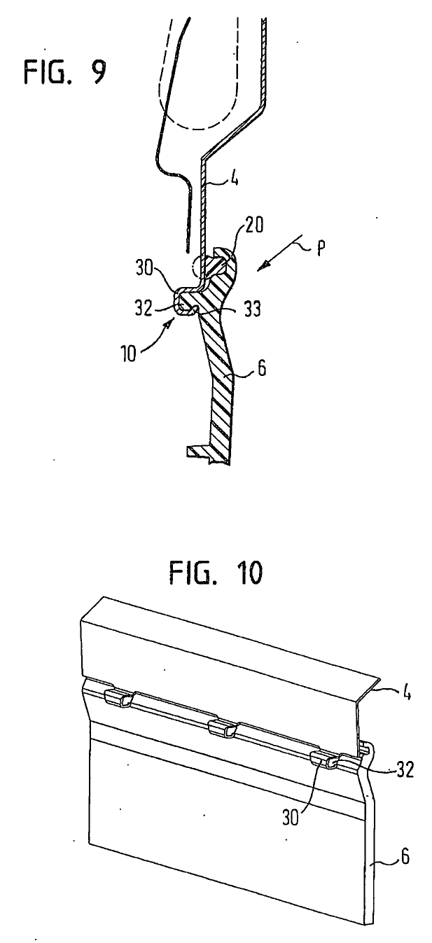

FIGS. 9 and 10 show a latching connection or a hook connection 10 for a fourth embodiment. In this embodiment the inside door steel sheet 4 has a snap-on hook 30 that has a generally rectangular shape which is open on one side, as seen in cross-section. At the open side, the snap-on hook 30 has an upwardly bent edge portion 33. The snap-on hook 30 encompasses a retaining protrusion 32 that is arranged at the upper edge of the carrier element 6 and has a groove on an underside at a transition to the body of the carrier element 6. The bent edge portion 33 of the snap-on hook comes to lie in this groove. During installation, the carrier element 6 is added to the inside door steel sheet 4 in a direction indicated by arrow P. In doing so, the snap-on hook 30 slightly widens, until the retaining protrusion 32 is encompassed completely, and the carrier element 6 is fixedly mounted to the inside door steel sheet 4.

The snap-on hook 30 could also have shapes that differ from the shape shown in FIGS. 9 and 10.

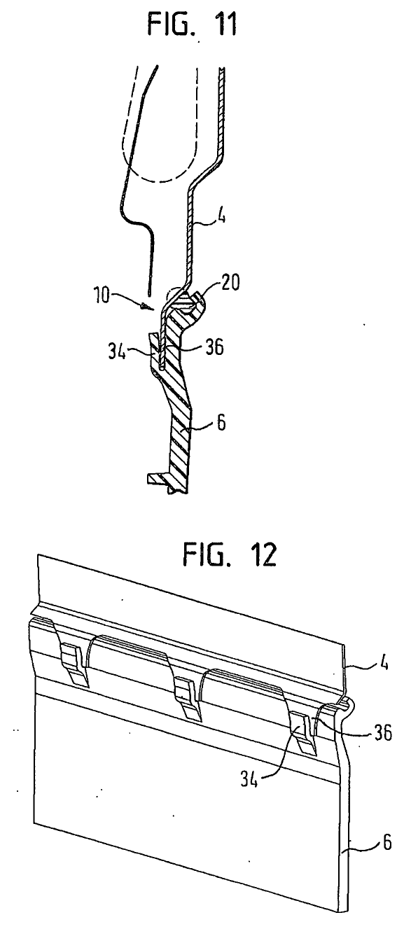

FIGS. 11 and 12 show a latching connection or a hook connection 10 for a fifth embodiment. In this embodiment, a hook 34 is formed at the upper edge of the carrier element 6. The hook 34 has an extension that extends upwardly relative to the body of the carrier element 6 such that a gap is formed, which narrows like a wedge. The hook 34 reaches behind a retaining lug 36 defined on the inside door steel sheet 4, so that this retaining lug 36 is received in the gap that narrows like a wedge. As can be seen in FIG. 12, a plurality of hooks 34 and retaining lugs 36 is provided, which are spaced apart from each other. A seal 20 between the carrier element 6 and the inside door steel sheet 4 is also provided in this embodiment. This seal 20 engages an obliquely extending sealing portion on the inside door steel sheet 4 when the carrier element 6 is pushed onto the edge of the inside door steel sheet 4 in the vertical direction.

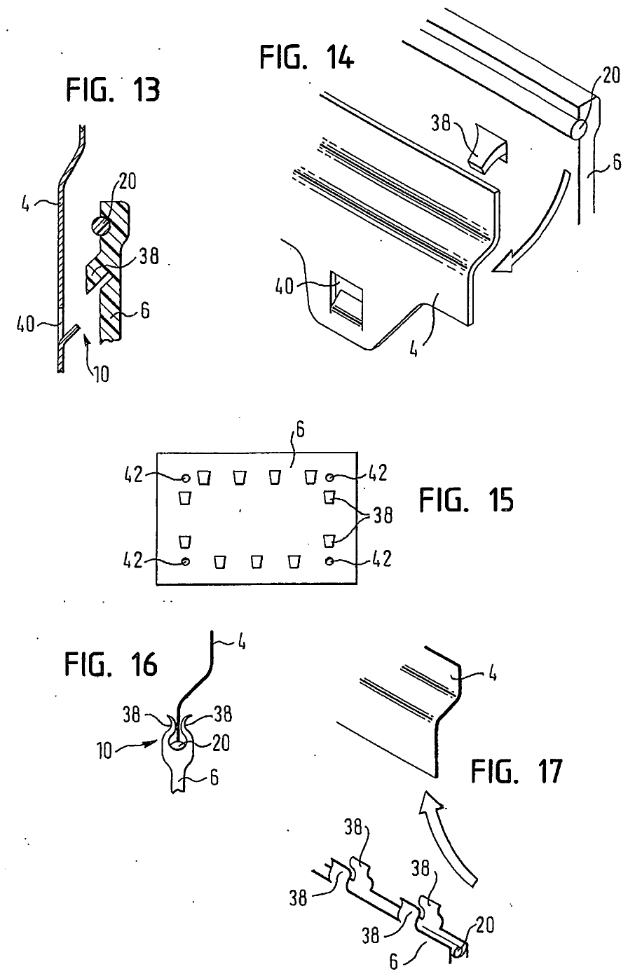

FIGS. 13 to 15 show a latching connection or a hook connection 10 for a sixth embodiment. In this arrangement, the carrier element 6 has a plurality of lugs 38 that obliquely extend downward and engage in associated receiving openings 40 provided on the inside door steel sheet 4. The receiving openings 40 on the inside door steel sheet 4 can be formed by suitably stamping the inside door steel sheet 4 and bending formed webs out of a plane defined by the inside door steel sheet 4. As can be seen in FIG. 15, the lugs 38 can be arranged along an outer circumference of the carrier element 6. Only four screw holes 42 are provided that serve for the final fastening of the carrier element 6, which is fixed with the lugs 38.

FIGS. 16 and 17 show a latching connection or a hook connection 10 for a seventh embodiment. With this embodiment, the upper edge of the carrier element 6 is provided with a plurality of lugs 38 that extend in opposite directions and engage on both sides of an edge, having a planar downward extension, of the inside door steel sheet 4 when the carrier element 6 is added to the inside door steel sheet 4 from the bottom. A seal 20 is arranged at the bottom of a groove that is formed between the lugs 38.

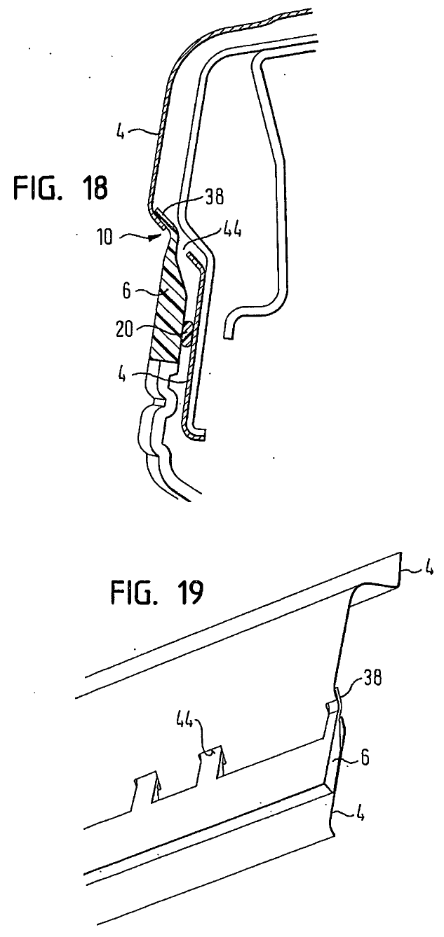

FIGS. 18 and 19 show a latching connection or a hook connection 10 for an eighth embodiment. Here the carrier element 6 has a plurality of obliquely extending lugs 38, and the inside door steel sheet 4 has a plurality of recesses 44 associated with the lugs 38. The recesses 44 are defined in a portion of the inside door steel sheet 4 that extends obliquely in the same way as the lugs 38. For installation, the carrier element 6 is added to the inside door steel sheet 4 with such an oblique orientation that the lugs 38 approximately vertically project to the top. The lugs 38 will then be inserted in the recesses 44 and the carrier element 6 is swiveled downwards, so that the lugs 38 are tilted into a position in which the lugs 38 are approximately parallel to a portion of the inside door steel sheet 4 that extends obliquely and contains the recesses 44. In this position the lugs 38 are locked above the recesses 44 and behind these. During swiveling of the carrier element 6, a seal 20 between inside door steel sheet 4 and carrier element 6 will be compressed.

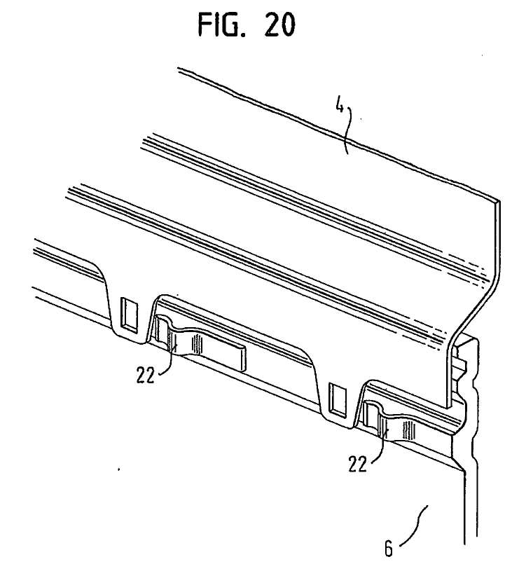

FIG. 20 shows a ninth embodiment of the invention. This embodiment is based on the second embodiment, with the latching lugs 22 not being arranged in a vertical direction, but instead being arranged in a horizontal direction. To fasten the carrier element 6 to the inside door steel sheet 4, the carrier element 6 is shifted in the horizontal direction relative to the inside door steel sheet 4 until the latching lugs 22 latch in place in recesses in the inside door steel sheet 4.

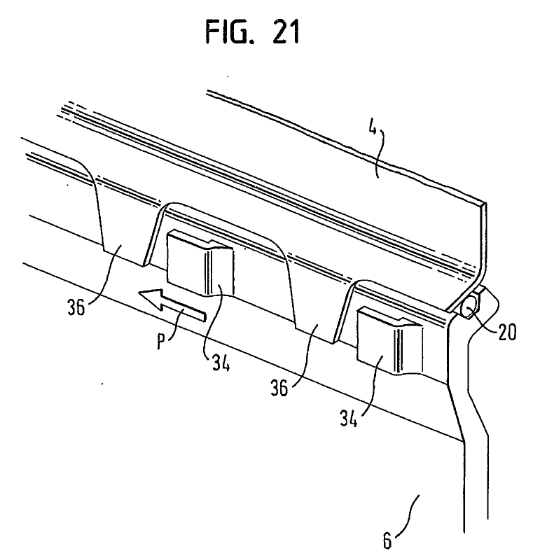

FIG. 21 shows a tenth embodiment of the invention. This embodiment is based on the fifth embodiment, with the hooks 34 extending in horizontal direction. Also here, the carrier element 6 is shifted in the horizontal direction relative to the inside door steel sheet 4, in the same manner as with the ninth embodiment. The hooks 34 thereby reach behind the retaining lugs 36 of the inside door steel sheet 4 and fasten the carrier element 6 to the inside door steel sheet 4.

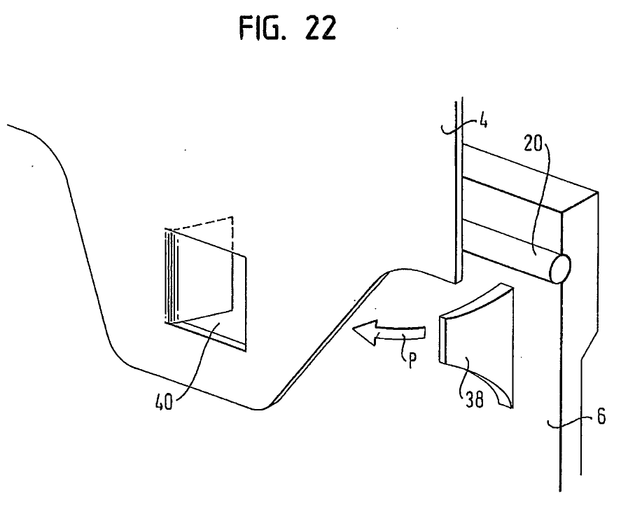

FIG. 22 shows an eleventh embodiment of the invention. This embodiment is based on the sixth embodiment, with the lugs 38 extending in the horizontal direction. Again, the carrier element 6 is shifted in the horizontal direction relative to the inside door steel sheet 4, in the same manner as with the ninth and tenth embodiment. The lugs 38 thereby engage in the recesses 44 of the inside door steel sheet 4.

The latching connection or the hook connection 10 according to the invention can be employed in various ways. On the one hand, the latching connection or the hook connection 10 can be provided only at one edge of the carrier element 6, for instance at the upper edge. For installation, this edge is hung up on the inside door steel sheet 4 in a simple manner. Subsequently, the carrier element 6 is swiveled such that an opposite edge, for instance the lower edge, rests against the inside door steel sheet 4. As a final step, a few fastening screws are mounted and tightened, so that the carrier element 6 is firmly attached to the inside door steel sheet 4.

On the other hand it would be possible to provide the latching connection or the hook connection 10 according to the invention at several edges, or even all edges, of the carrier element 6. The carrier element 6 will then be flatly added to the inside door steel sheet 4, shifted in one direction so that all latching connections or all hook connections 10 are brought into engagement, and screwed down finally. Only very few fastening screws are necessary in this case, because the screws solely have the function of preventing a displacement of the carrier element 6 relative to the inside door steel sheet 4 in a direction that is opposite relative to the shifting during installation.

When the latching connection or the hook connection 10 is provided on all edges of the carrier element 6, it would be possible, for instance, to use the lugs and hooks of the embodiment according to FIG. 13 to 15 along all the edges. The carrier element 6 would have to be shifted from the top to the bottom relative to the inside door steel sheet 4 in this case. If the latching connection or the hook connection 10 according to FIGS. 20 to 22 is used along all the edges of the carrier element 6, the latter has to be shifted in the horizontal relative to the inside door steel sheet 4. Hereby it suggests itself to shift the carrier element 6 from the front to the rear, as this is of advantage with respect to a door lock which likewise can be pre-mounted to the carrier element 6.

It is also possible, of course, to combine latching connections or hook connections according to different embodiments on one and the same carrier element. It is even possible to combine different latching connections or hook connections on one and the same edge of a carrier element, if this appears to be of advantage.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. An assembly unit comprising:
an inside door steel sheet; and
a carrier element fastened to the inside door steel sheet, wherein the carrier element has at least one edge hung on the inside door steel sheet with one of a latching connection and a hook connection.

2. The assembly unit according to claim 1 wherein the carrier element has a groove at the at least one edge, and wherein the one of the latching connection and the hook connection comprises at least one hook provided on the inside door steel sheet that engages in the groove.

3. The assembly unit according to claim 2 wherein the groove is formed between a body of the carrier element and a rib protruding from the body.

4. The assembly unit according to claim 1 wherein the one of the latching connection and the hook connection comprises at least one latching lug provided at the at least one edge of the carrier element that encompasses an edge of the inside door steel sheet.

5. The assembly unit according to claim 4 wherein the edge of the inside door steel sheet is provided with a recess, a latching portion of the at least one latching lug reaching through the recess.

6. The assembly unit according to claim 5 wherein the edge of the inside door steel sheet is configured to be planar and the carrier element has an indentation in which the latching portion of the at least one latching lug comes to lie.

7. The assembly unit according to claim 5 wherein the edge of the inside door steel sheet is configured to be curved, so that in a region of the recess there is formed a free space between the inside door steel sheet and the carrier element.

8. The assembly unit according to claim 1 wherein the one of the latching connection and the hook connection comprises at least one articulation lug provided on the inside door steel sheet that engages in a counter bearing at the at least one edge of the carrier element.

9. The assembly unit according to claim 8 wherein the at least one articulation lug has a cross-section that is shaped like a segment of a circle.

10. The assembly unit according to claim 9 wherein the counter bearing defines a guideway for the at least one articulation lug.

11. The assembly unit according to claim 8 wherein the counter bearing laterally encompasses the at least one articulation lug.

12. The assembly unit according to claim 1 wherein the one of the latching connection and the hook connection comprises at least one snap-on hook and wherein the inside door steel sheet includes the at least one snap-on hook that encompasses a retaining protrusion that is arranged at the at least one edge of the carrier element.

13. The assembly unit according to claim 12 wherein the at least one snap-on hook comprises a bent-off latching portion that engages in a groove on the retaining protrusion.

14. The assembly unit according to claim 1 wherein the one of the latching connection and the hook connection comprises at least one hook provided at the at least one edge of the carrier element that reaches behind a retaining lug on the inside door steel sheet.

15. The assembly unit according to claim 14 wherein an obliquely extending sealing portion on the inside door steel sheet adjoins the retaining lug.

16. The assembly unit according to claim 1 wherein the one of the latching connection and the hook connection comprises a plurality of obliquely extending lugs provided on one of the inside door steel sheet and carrier element, and receiving openings for the plurality of obliquely extending lugs provided on the other of the inside door steel sheet and carrier element.

17. The assembly unit according to claim 16 wherein the plurality of obliquely extending lugs is arranged along an outer circumference of the carrier element.

18. The assembly unit according to claim 1 wherein the one of the latching connection and the hook connection comprises a plurality of lugs that protrude from the at least one edge of the carrier element in opposite directions, the plurality of lugs engaging sides on the inside door steel sheet facing away from each other.

19. The assembly unit according to claim 1 wherein the one of the latching connection and the hook connection comprises a plurality of lugs that obliquely protrude from the at least one edge of the carrier element, and wherein the inside door steel sheet has a plurality of recesses associated to the plurality of lugs, the plurality of recesses being arranged in an obliquely extending portion of the inside door steel sheet.

20. The assembly unit according to claim 1 wherein the carrier element is made of plastic.

21. The assembly unit according to claim 1 including a seal arranged between the at least one edge of the carrier element and the inside door steel sheet.

22. The assembly unit according to claim 1 wherein the one of the latching connection and the hook connection is arranged at an upper edge of the carrier element.

23. The assembly unit according to claim 1 wherein the one of the latching connection and the hook connection is arranged at one of a front and a rear edge of the carrier element.

24. The assembly unit according to claim 1 wherein the one of the latching connection and the hook connection is arranged at a lower edge of the carrier element.

25. The assembly unit according to claim 1 including screws that connect the carrier element with the inside door steel sheet.

26. The assembly unit according to claim 1 wherein the carrier element is shifted relative to the inside door steel sheet during installation.

27. The assembly unit according to claim 26 wherein the carrier element is shifted in the vertical direction.

28. The assembly unit according to claim 26 wherein the carrier element is shifted in a horizontal direction.
